(19) United States
(12) Patent Application Publication
(10) Pub. No.: US 2017/0110859 A1
(43) Pub. Date: Apr. 20, 2017

(54) CABLE INSTALLATION TOOL AND METHOD FOR SUCH INSTALLATION

(71) Applicant: Aker Solutions AS, Lysaker (NO)

(72) Inventors: Finn Peter GJERULL, Høvik (NO); Sigvard OMVIK, Moss (NO)

(73) Assignee: Aker Solutions AS, Lysaker (NO)

(21) Appl. No.: 15/312,793

(22) PCT Filed: Jun. 1, 2015
(86) PCT No.: PCT/NO2015/050097

§ 371 Date: Nov. 21, 2016

(30) Foreign Application Priority Data
Jun. 5, 2014 (NO) 20140710

(51) Int. Cl. H02G 1/10; F16L 55/46

(52) U.S. Cl. CPC H02G 1/10; F16L 55/46

(57) ABSTRACT

An installation tool arrangement enables installation of a flexible elongated element, such as a conductor, cable, tube or tube bundle, into a pipeline and to extend the flexible elongated element from the surface of the sea to the seabed by the use of a per se known pipeline pigging technique. The tool arrangement includes a first pipe junction tool at the pipeline entrance end for the flexible elongated element, and a second pipe junction tool at the pipeline exit end for the flexible elongated element. The installation tool arrangement includes a leading pig connected to the flexible elongated element to have it advanced through the pipeline toward the seabed by advancing said pig by means of the fluid flowing in the pipeline.

The present invention relates to a cable installation tool, also intended for retrofit installation in existing pipelines.

More precisely, the invention relates to an installation tool arrangement to enable installation of a flexible elongated element, such as a conductor, cable, tube or tube bundle, into a pipeline and to extend said flexible elongated element from the surface of the sea to the seabed by the use of a per se known pipeline pigging technique, which tool arrangement includes a first pipe junction tool at the pipeline entrance end for the flexible elongated element, and a second pipe junction tool at the pipeline exit end for the flexible elongated element.

The present invention also relates to a method for introducing a flexible elongate element into a pipeline transporting fluids from the surface to the seabed.

There is no relevant prior art to describe that we are aware about, other than a predecessor application relating to a subsea filler line system, as disclosed in NO 2013 1683. The present invention was intended to be an integrated part of that subsea filler line system, but it is recognized that the invention as well could be used alone as an independent way of bringing a cable from the sea surface to the seabed through either an existing or new pipeline.

This is solved by an installation tool of the introductory said kind, which is distinguished in that said installation tool arrangement further includes a leading pig connected to said flexible elongated element and arranged to enter said pipeline at said first pipe junction tool, said pig and trailing flexible elongated element entering said pipeline via a branch off pipe of said first pipe junction tool, said pig and flexible elongated element being prepared to be advanced through said pipeline toward the seabed by advancing said pig by means of the fluid flowing in the pipeline, and means to shift said flexible elongated element to a connecting terminal for said flexible elongated element at the second pipe junction tool.

In one embodiment of the invention, the first pipe junction tool can be a retrofit tool which is prepared for retrofit installation in a pipeline.

Further, the first pipe junction tool can be a retrofit tool arranged with flanges for connection to a cut off pipeline provided with respective flanges.

Preferably, the branch off pipe of the first pipe junction tool can include a seal box with a seal package sealing around the flexible elongated element during the advancement thereof through the pipeline.

In a preferable embodiment, the first pipe junction tool can be prepared as a modified pig launcher.

Suitably, the first pipe junction tool may include a cable conveyor in order to assist in feeding and advancing the flexible elongated element.

In a preferable embodiment, the second pipe junction tool can be a retrofit tool prepared for retrofit installation in a pipeline.

In still a preferable embodiment, the second pipe junction tool can be a retrofit tool arranged with flanges for connection to a cut off pipeline provided with respective flanges.

In still another preferable embodiment, the second pipe junction tool can be a modified pig receiver.

Preferably, the second pipe junction tool includes a pig receiver housing and a pig receiver slide, which pig receiver slide is able to shift said flexible elongated element to the connecting terminal for the flexible elongated element at the second pipe junction tool.

The present invention also relates to a subsea filler line system having an integrated installation tool arrangement according to the following claims 1 to 10, which subsea filler line system is adapted to transport different types of fluids in separate batches through one single supply conduit, or flexible line, from the sea surface to respective dedicated storage tanks, or vessels, installed on the seabed, which system includes respective valves and control systems to operate the subsea filler line system, the system being distinguished in that the subsea filler line system includes at least two pigs adapted to be pushed by the transported fluid through the supply conduit, or flexible line, which pigs further provide a barrier between the respective fluids in front of and behind each pig, thus being able to define respective fluid batches between following pigs, each fluid batch being directed by means of valves through an inlet into the supply conduit and an outlet from the supply conduit and further on to the respective dedicated storage tanks, or vessels, on the seabed.

Also a subsea filler line system taking advantage of the invention is described. The subsea filler line system is adapted to transport different types of fluids in separate batches through one single supply conduit, or flexible line, from the sea surface to respective dedicated storage tanks, or vessels, installed on the seabed, which system includes respective valves and control systems to operate the subsea filler line system, which subsea filler line system includes at least two pigs adapted to be pushed by the transported fluid through the supply conduit, or flexible line, which pigs further provide a barrier between the respective fluids in front of and behind each pig, thus being able to define respective fluid batches between following pigs, each fluid batch being directed by means of valves through an inlet into the supply conduit and an outlet from the supply conduit and further on to the respective dedicated storage tanks, or vessels, on the seabed, the system being distinguished in that the subsea filler line system further includes an installation tool arrangement to enable installation of a flexible elongated element, such as a conductor, cable, tube or tube bundle, into a pipeline and to extend the flexible elongated element from the surface of the sea to the seabed by the use of a per se known pipeline pigging technique, which tool arrangement includes a first pipe junction tool at the pipeline entrance end for the flexible elongated element, and a second pipe junction tool at the pipeline exit end for the flexible elongated element, which installation tool arrangement further includes a leading pig connected to the flexible elongated element and arranged to enter the pipeline at the first pipe junction tool, which pig and trailing flexible elongated element entering the pipeline via a branch off pipe of the first pipe junction tool, which pig and flexible elongated element being prepared to be advanced through the pipeline toward the seabed by advancing the pig by means of the fluid flowing in the pipeline, and means to shift the flexible elongated element to a connecting terminal for the flexible elongated element at the second pipe junction tool.

The subsea filler line system may include a pig launcher having a pig stopper able to both retain a pig and release a pig into the supply conduit.

Normally, the pig launcher comprises the fluid inlet and the pig stopper, which inlet and pig stopper are spaced apart by at least on pig length.

The subsea filler line system may include a pig lock adjacent to the subsea storage tanks, which pig lock includes a pig stopper able to both retain a pig and discharge a pig into a pig receiver, which pig receiver, as an option, can be retrievable.

Further, the pig lock may include the fluid outlet and the pig stopper, which outlet and pig stopper are spaced apart by at least on pig length.

Conveniently, the subsea filler line system includes a battery of subsea storage tanks interconnected by a pipe manifold, which pipe manifold has a respective branch pipe to each individual storage tank, each respective branch pipe being provided with an inlet valve able to shut off/open up the flow to the storage tank by means of the control system.

Each subsea storage tank, or respective branch pipe, may include a fluid pipe with a shut off/open up valve extending to a dedicated equipment on a subsea installation, which valve being operated by means of the control system.

Further, the single supply conduit may include a first shut off/open up mainline valve adjacent to the pig launcher and a second shut off/open up mainline valve adjacent to the pig lock on the seabed, which valves being operable by means of the control system and enables installation/replacement of the single supply conduit.

Still further, the single supply conduit can include a third shut off/open up mainline valve adjacent to, but in the extension of the pig lock on the seabed, which valve being operated by means of the control system and enables isolation of the filler line system when replacing the pig receiver.

As indicated, the present invention also relates to a method for introducing a flexible elongate element into a pipeline transporting fluids from the surface to the seabed, said method being distinguished in that:
a) a first pipe junction, having a main pipe and a branch off pipe, is installed on the pipeline, which first pipe junction includes a pig being prepared to be launched into said pipeline, and to which said flexible elongate element is secured, which flexible elongate element is coming into said pipeline via said branch off pipe and in a sealed way,
b) exposing said pig for a fluid flow in said pipeline, which displaces said pig in the flow direction,
c) continue to displace said pig and said flexible elongate element by said fluid flow until said pig reaches a pig receiver installed on said pipeline on the seabed,
d) let said pig enter a pig receiver slide in said pig receiver,
e) shift said pig and pig receiver slide out of said pipeline pathway to enable to resume full flow through said pipeline.

### EXAMPLE OF EMBODIMENT

While the various aspects of the present invention has been described in general terms above, a more detailed and non-limiting example of an embodiment will be described in the following with reference to the drawings, in which:

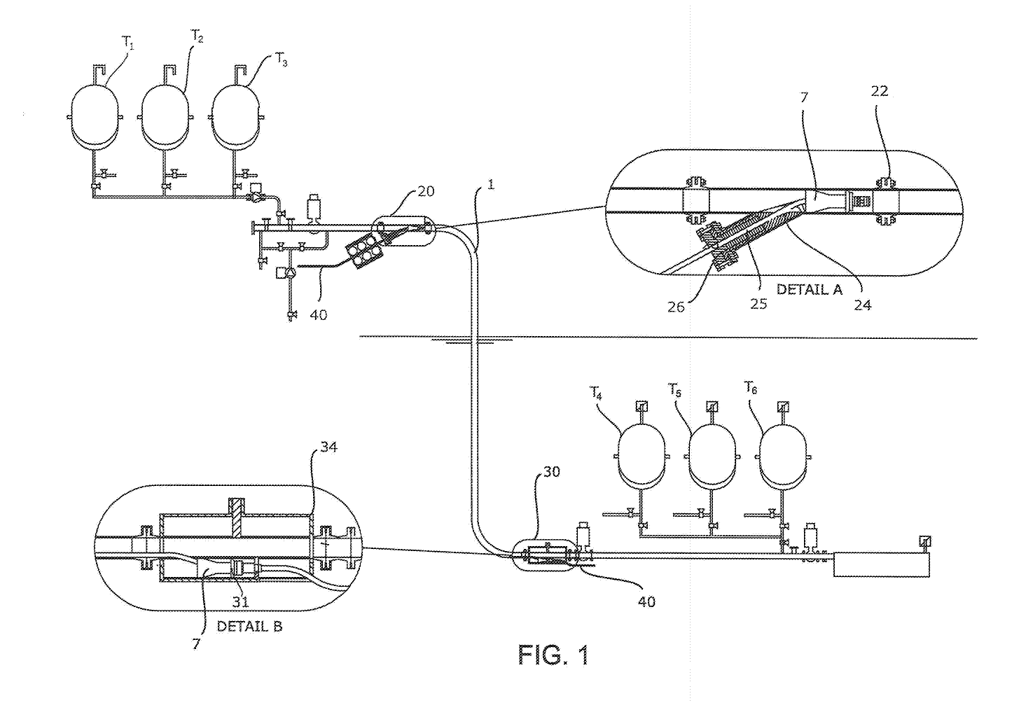

FIG. 1 is a schematic view of a subsea filler line system that also includes an installation tool arrangement according to the present invention.

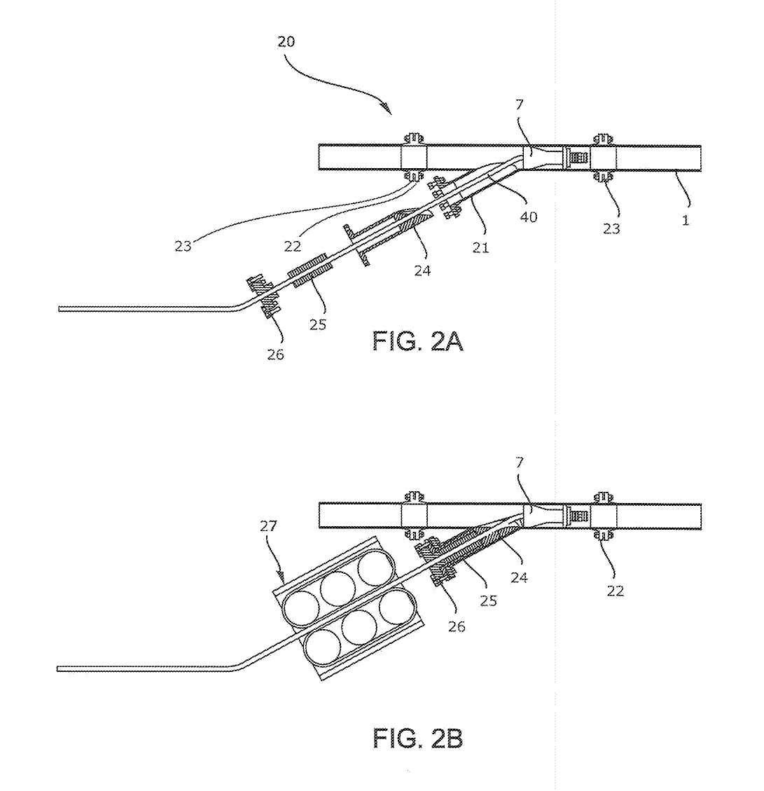

FIG. 2A is a schematic and enlarged view of the first pipe junction tool according to the present invention with the parts brought apart from each other,

FIG. 2B is a schematic and enlarged view of the first pipe junction tool according to the present invention with the parts assembled,

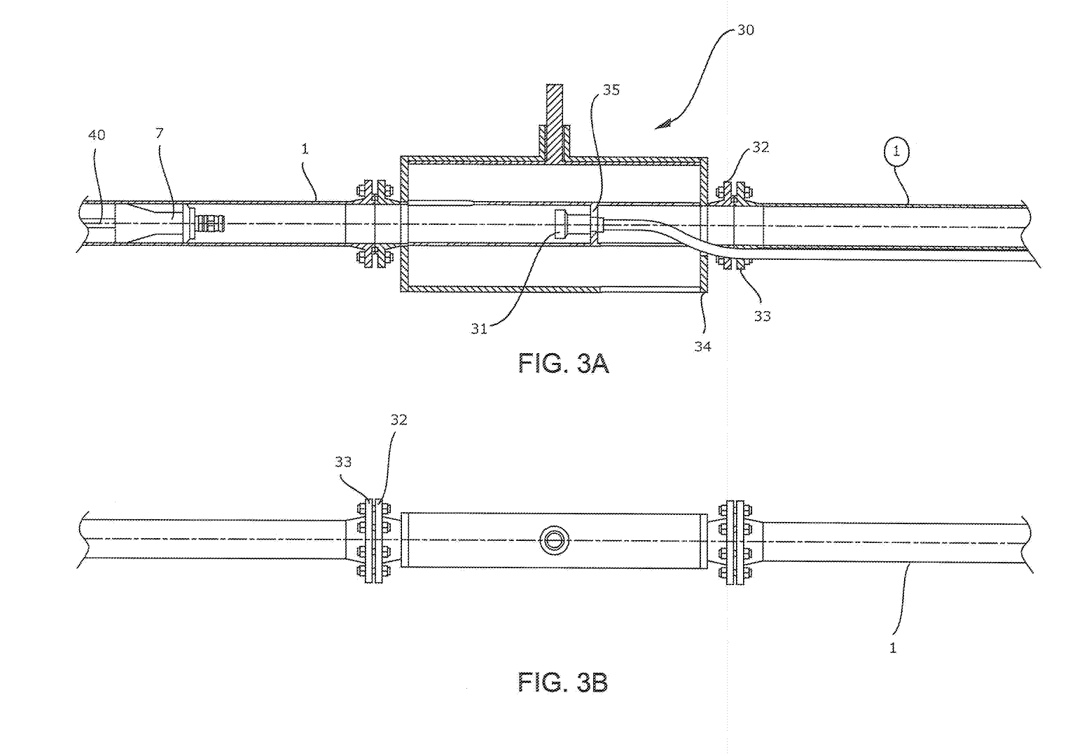

FIG. 3A is a schematic and enlarged elevated view of the second pipe junction tool according to the present invention with a pig receiver ready to receive the arriving pig and cable,

FIG. 3B is a schematic and enlarged top view of the second pipe junction tool according to the present invention,

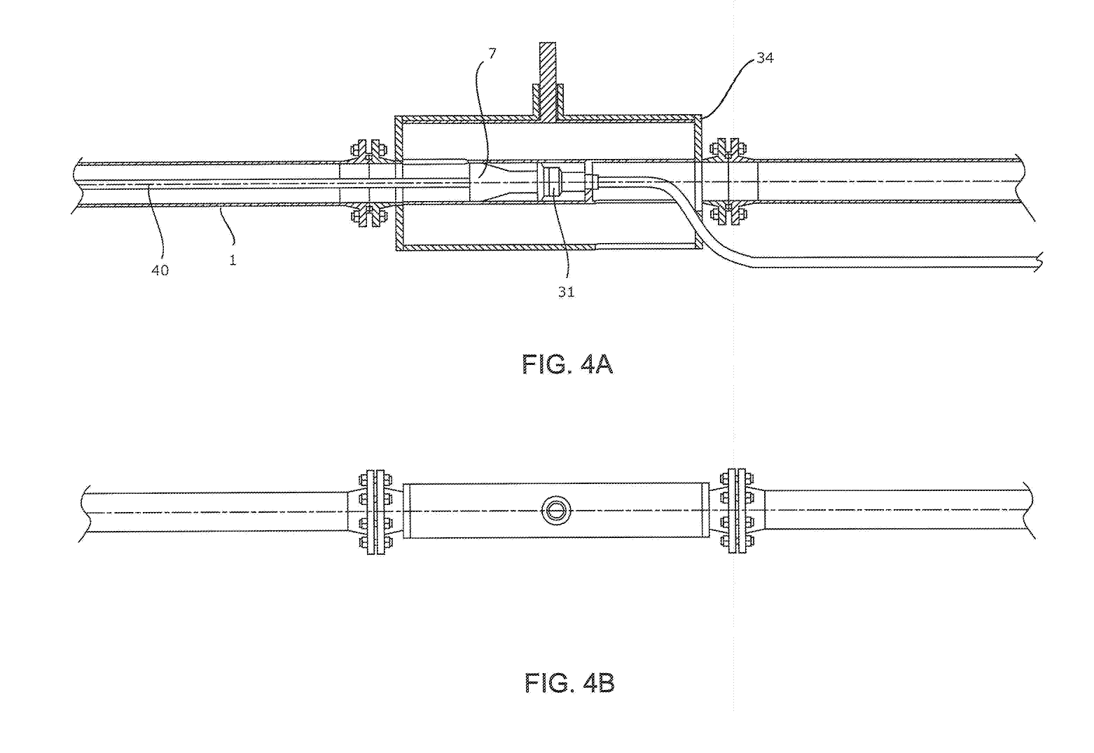

FIG. 4A is a schematic and enlarged elevated view of the second pipe junction tool according to FIG. 3A with the pig arrived in the receiving connector terminal,

FIG. 4B is a schematic and enlarged top view of the tool according to FIG. 4A,

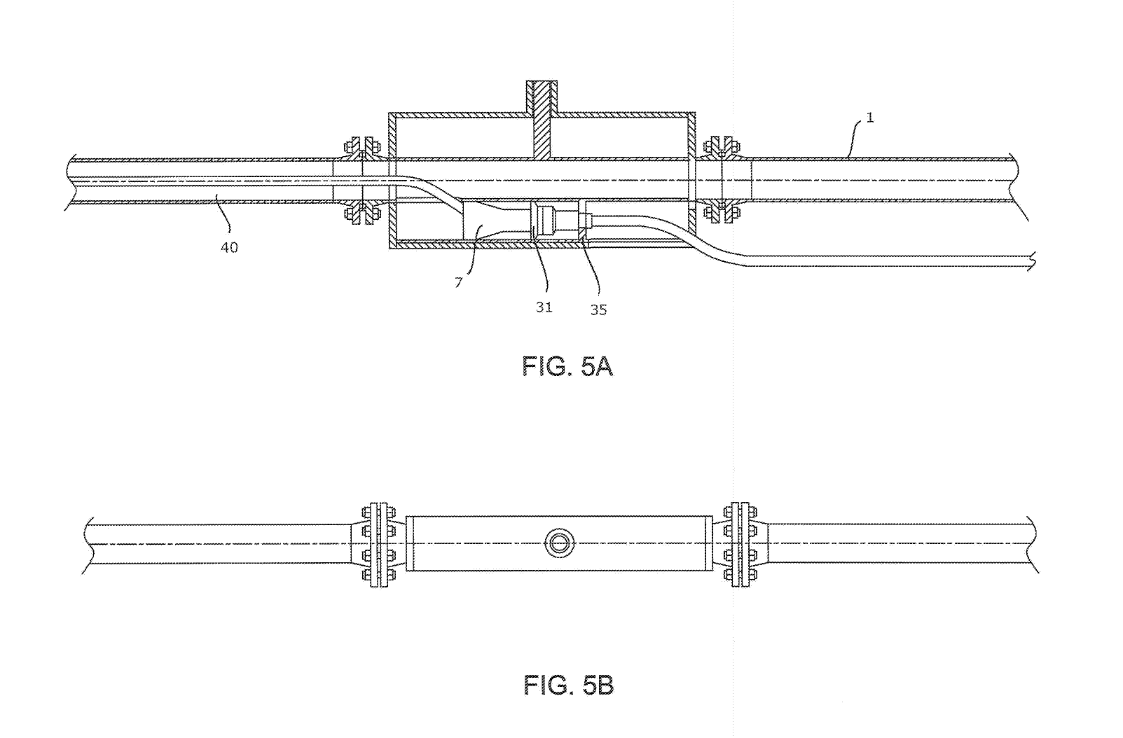

FIG. 5A is a schematic and enlarged elevated view of the second pipe junction tool according to FIG. 3A with the pig and terminal shifted out of the pipeline,

FIG. 5B is a schematic and enlarged top view of the tool according to FIG. 5A,

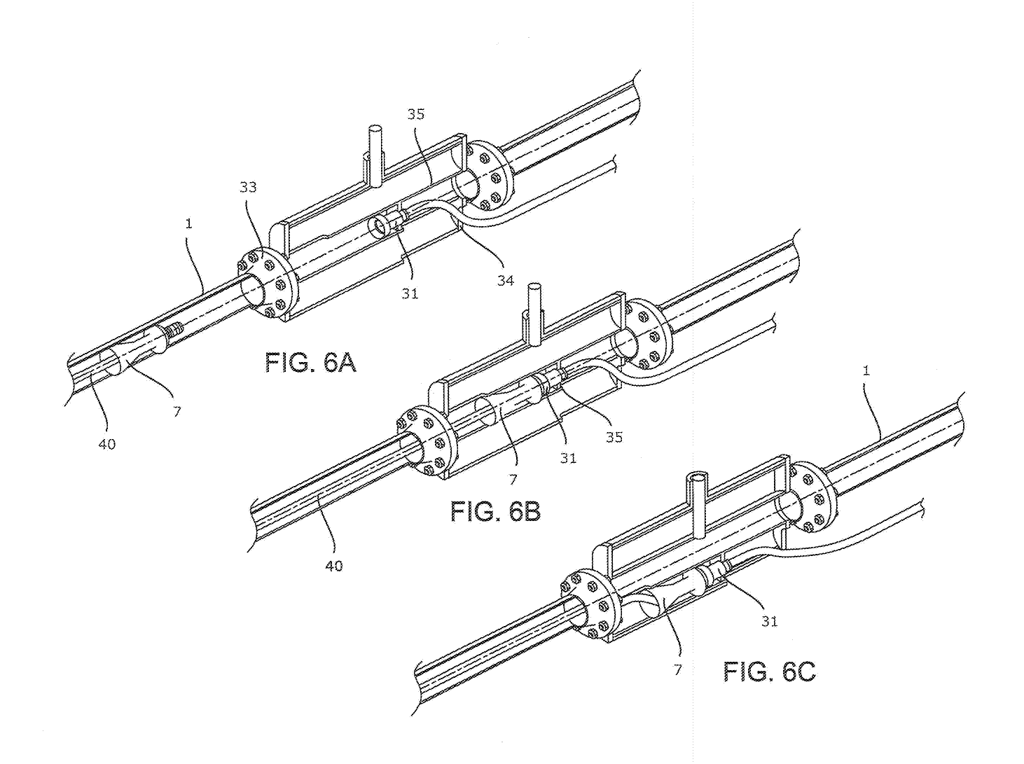

FIG. 6A-6C are perspective views of the second pipe junction tool shown in the respective positions in FIGS. 3A, 4A and 5A,

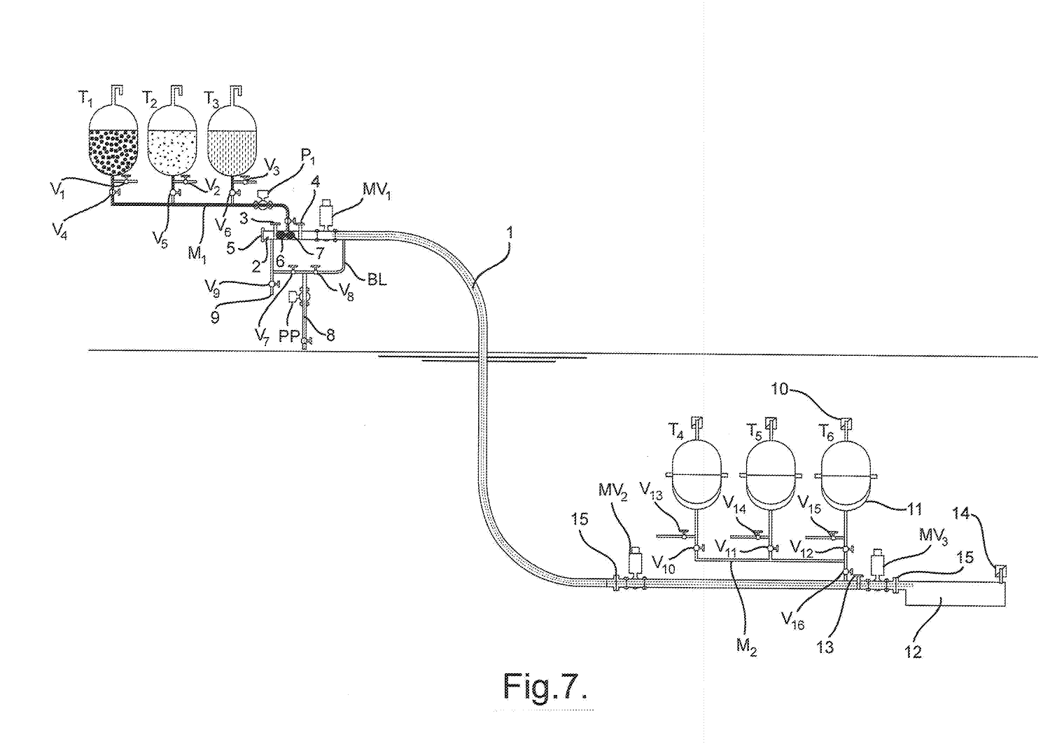

FIG. 7 is a schematic view of an independent subsea filler line system to which the present tool arrangement can be installed and according to a first stage of operation,

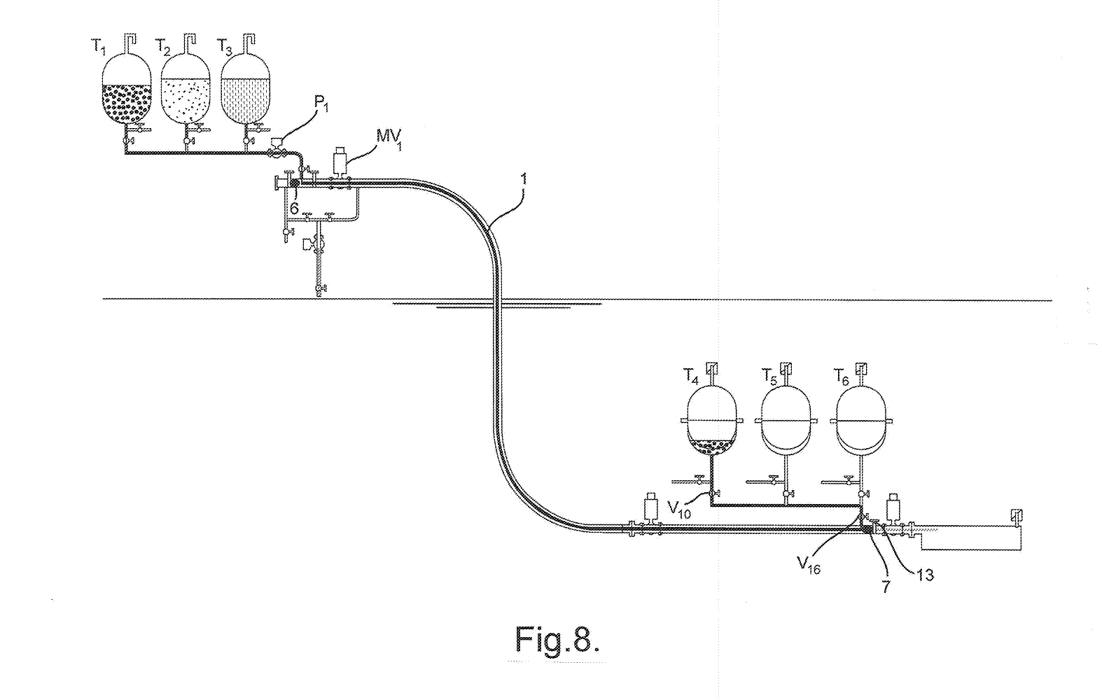

FIG. 8 is a schematic view of the subsea filler line system according to FIG. 7 in a second stage of operation,

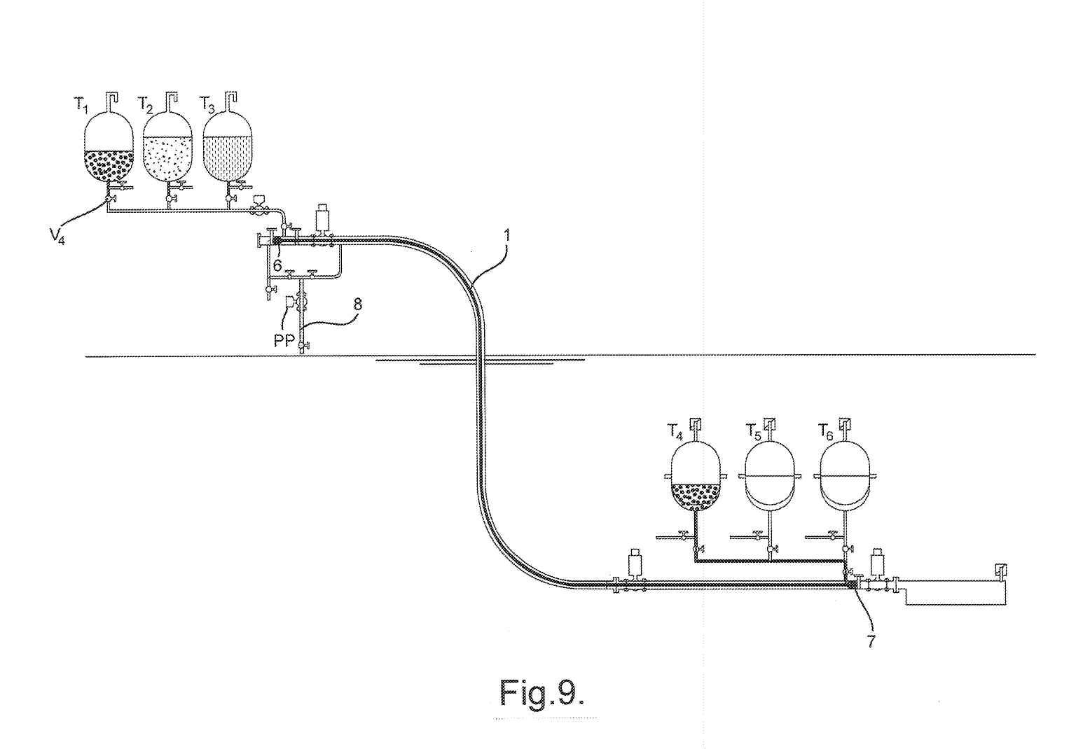

FIG. 9 is a schematic view of the subsea filler line system according to FIG. 7 in a third stage of operation,

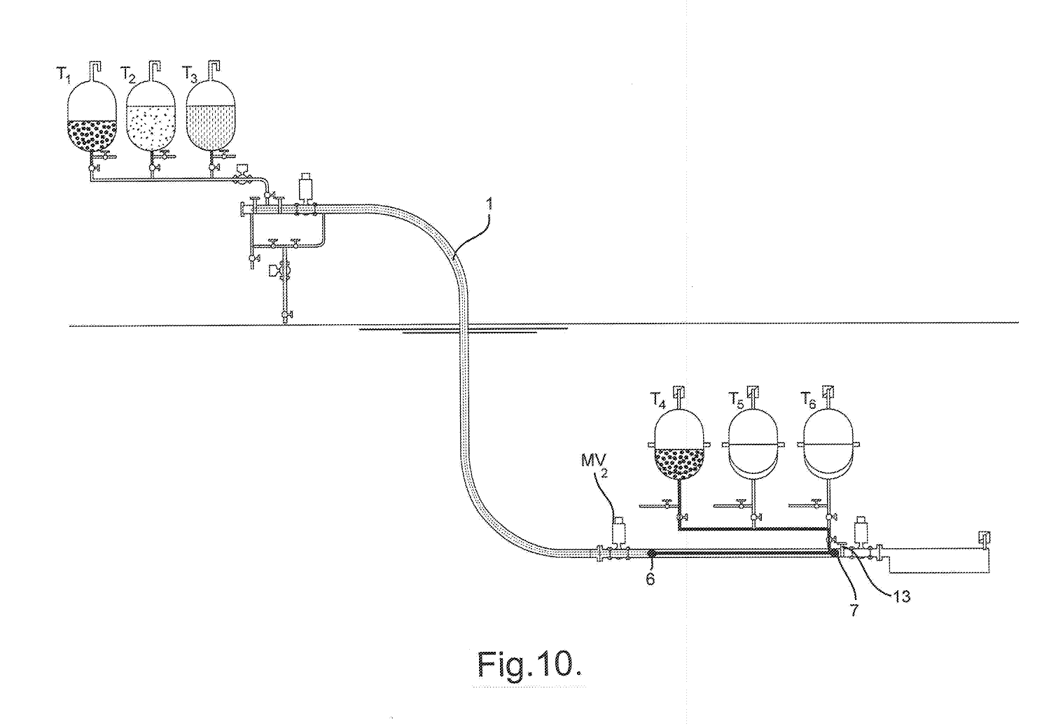

FIG. 10 is a schematic view of the subsea filler line system according to FIG. 7 in a fourth stage of operation,

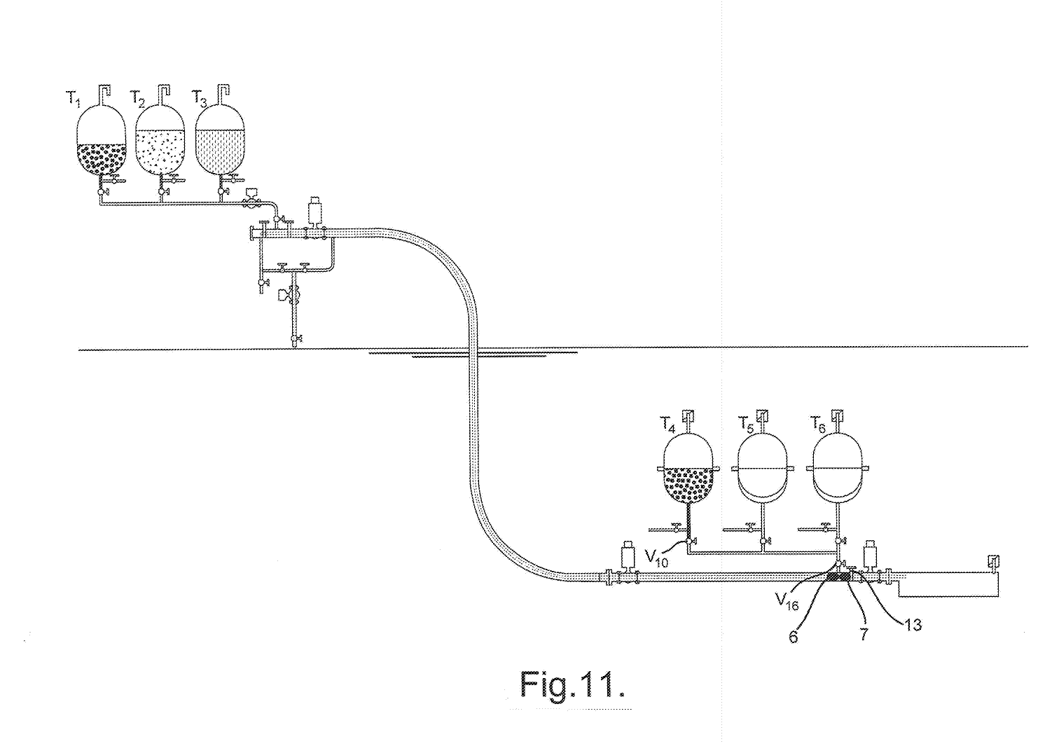

FIG. 11 is a schematic view of the subsea filler line system according to FIG. 7 in a fifth stage of operation,

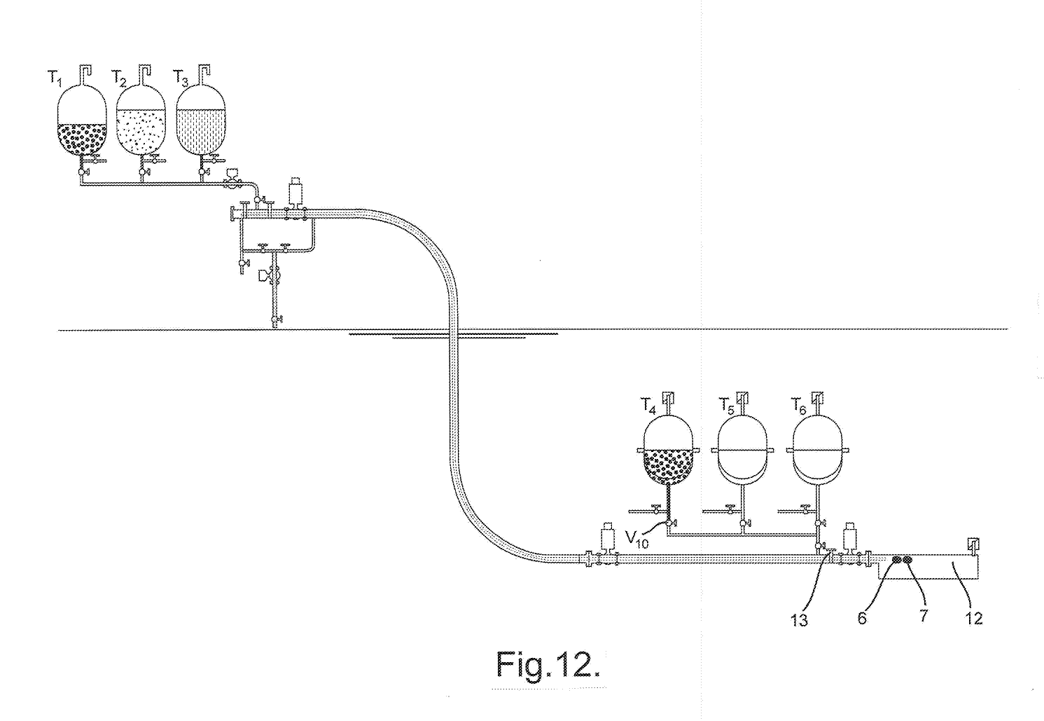

FIG. 12 is a schematic view of the subsea filler line system according to FIG. 7 in a sixth stage of operation,

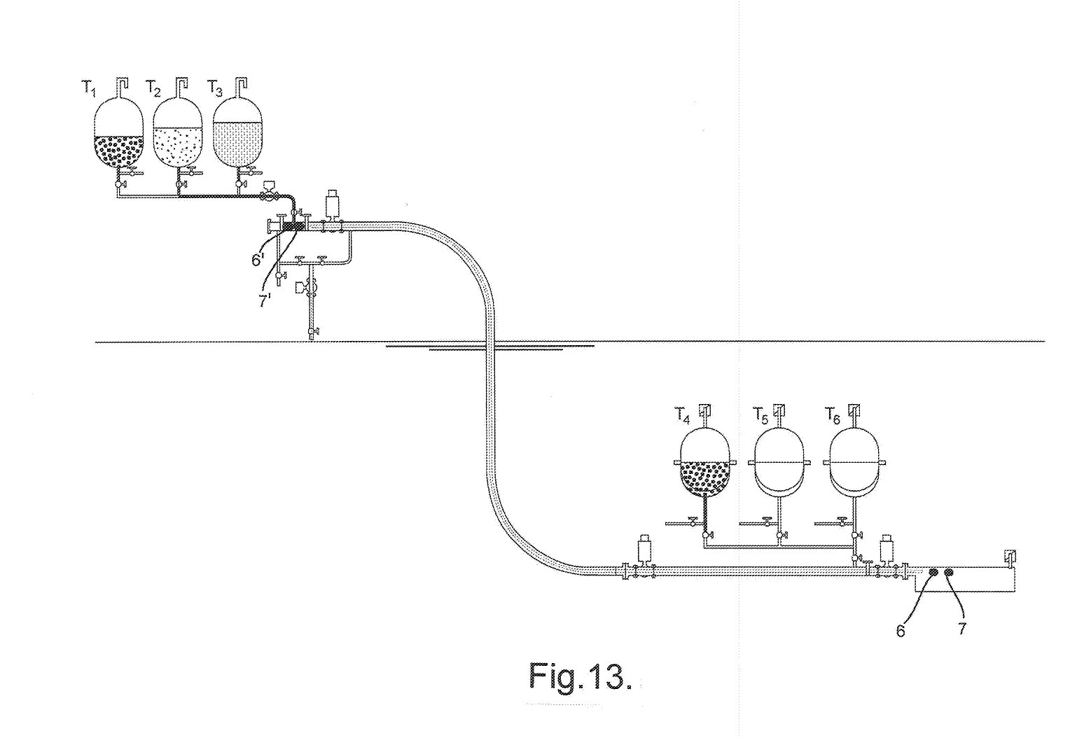

FIG. 13 is a schematic view of the subsea filler line system according to FIG. 7 in a seventh stage of operation,

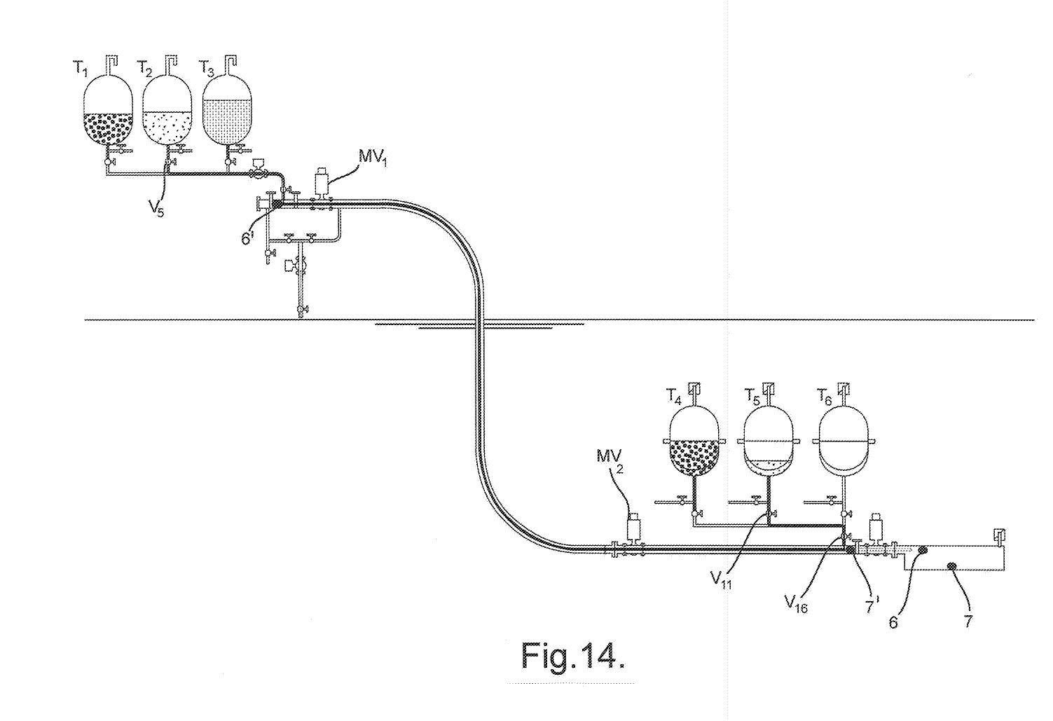

FIG. 14 is a schematic view of the subsea filler line system according to FIG. 7 in an eighth stage of operation.

Reference is first made to FIG. 1 which shows, though kind of schematic, a complete subsea filler line system where a master fluid conduit 1 extends from three tanks T₁, T₂, T₃ on the surface of the water to three tanks T₄, T₅, T₆ located on the seabed. Each tank T₁ T₂, T₃ contain a unique liquid or fluid and will normally be installed onboard a surface vessel or surface facility. Each unique fluid is to be transported as a batch to a dedicated seabed tank T₄, T₅, T₆ via the master fluid conduit 1. A purge fluid is to be sent through the master fluid conduit 1 between each batch to be transported. As previously stated, a main objective with the above arrangement is to keep the respective fluids isolated from each other, i.e. that the various fluids are not able to contaminate each other during such transfer from the sea surface to the seabed, even if one and the same master fluid conduit 1 is to be used for all the fluids.

The general subsea filler line system is as presented in the above referred NO 2013 1683, and reference is given to that document to have further details about such subsea filler line system. The present invention relates more precisely to the installation tool arrangement 20, 30 either integrated into the above described subsea filler line system, or to be used in connection with other kind of pipe or fluid line extending from the sea surface to the seabed. These are indicated as “Detail A” and “Detail B” in FIG. 1.

The term “tool” and arrangement are deliberately used because the first, or upper, pipe junction tool 20 can be used as a retrofit apparatus on an existing pipeline. Such pipeline needs to be cut and brought apart for installation of the tool 20, or split open, typically through a flanged connection or a subsea connector system. Also the second, or lower, pipe junction tool 30 can be used as a retrofit apparatus on an existing pipeline. Also here the pipeline needs to be cut and brought apart for installation of the second tool 30, or split open, typically through a flanged connection or a subsea connector system. However, the normal will be that these “tools” 20, 30 are installed when constructed, but can be used at any time during the life span of the pipeline. And it is to be noted that the arrangement can be used to bring a flexible elongated element 40, like a cable, conductor, tube or tube bundle, from the sea surface to the seabed in a shielded way within the conduit 1 whatever the use on the seabed might be, existing or new equipment to be located there.

Thus the respective tools 20, 30 are installed to enable installation of the flexible elongated element 40 into the pipeline 1 and to extend the flexible elongated element 40 from the surface of the sea to the seabed. This is in turn made possible by the use of a per se known pipeline pigging technique.

The arrangement locates the first pipe junction tool 20 at the pipeline 1 entrance end for the flexible elongated element 40, and the second pipe junction tool 30 at the pipeline exit end for the flexible elongated element 40.

Reference is now made to FIGS. 2A and 2B illustrating the first pipe junction tool 20 in closer detail. The installation tool arrangement further includes a leading pig 7, which pig 7 is connected to the flexible elongated element 40. The pig 7 is arranged to enter the pipeline 1 at the first pipe junction tool 20. The pig 7 and the trailing flexible elongated element 40 is entering the pipeline 1 via a branch off pipe 21 of the first pipe junction tool 20. The pig 7 and the flexible elongated element 40 are prepared to be advanced through the pipeline 1 towards the seabed by advancing the pig 7 by means of the fluid flowing in the pipeline 1.

As mentioned, the first pipe junction tool 20 can be made as a retrofit tool prepared for retrofit installation in a pipeline 1. Then the first pipe junction tool 20 is arranged with flanges 22 for connection to a cut off pipeline 1 provided with respective flanges 23.

The branch off pipe 21 of the first pipe junction tool 20 includes a seal box 24 with a seal package 25 sealing around the flexible elongated element 40 during the advancement thereof through the pipeline 1 and the branch off pipe 21. The seal box 24 is closed by a seal lid 26.

The first pipe junction tool 20 is like a modified pig launcher housing the pig 7 and the elongated element 40 fixed to the pig 7.

The first pipe junction tool 20 further includes a cable conveyor 27 to assist in feeding and advancing the flexible elongated element 40 through the branch off pipe 21 and the pipeline 1.

Reference is now made to FIGS. 3A and 3B illustrating the second pipe junction tool 30 in closer detail. As mentioned, the second pipe junction tool 30 can also be made as a retrofit tool prepared for retrofit installation in the pipeline 1. Then the second pipe junction tool 30 is arranged with flanges 32 for connection to a cut off pipeline 1 provided with respective flanges 33, or a subsea connector system.

Further, means are provided to enable shift of the flexible elongated element 40 to a connecting terminal 31 for the flexible elongated element 40 at the second pipe junction tool 30.

The second pipe junction tool 30 is like a modified pig receiver to house the advanced pig 7. The pig receiver includes a pig receiver housing 34 and a pig receiver slide 35. The pig receiver slide 35 is able to shift the flexible elongated element 40 to the connecting terminal 31 for the flexible elongated element 40 at the second pipe junction tool 30.

A detailed description of the subsea fluid filler line system will now follow with reference to FIGS. 8 to 14. This is described independently from the installation tool arrangement which are not depicted in FIGS. 8 to 14.

The filler pipe material will typically be either a corrosion resistant material or typical high strength carbon steel with protective coating. The material needs to be compatible with the fluids to be transferred.

The respective tanks T₁, T₂, T₃are interconnected by a first manifold Mi ending in a first upper end of the master fluid conduit 1. Each tank T₁, T₂, T₃ is in turn connected to an inlet pipe having an inlet valve V₁, V₂, V₃ that enables filling up the tanks T₁, T₂, T₃ with respective liquids or fluids. Further, each tank T₁, T₂, T₃ is provided with an outlet pipe having an outlet valve V₄, V₅, V₆ that enables drainage of the respective tanks T₁, T₂, T₃ into the master fluid conduit 1. Each tank T₁, T₂, T₃ is provided with a vent pipe on top to be able to ventilate each tank according to their respective filling level or degree. The first manifold M₁ is provided with a product pump P₁ in order to boost the pressure of the fluid to be transported.

At the first surface end of the master fluid conduit 1, a pig launcher 2 is provided, which pig launcher 2 is defined by a first and second pig stopper 3, 4, a pig launcher door 5, and two pigs 6, 7 ready to be launched, one at the time. Downstream of the second pig stopper 4, a first main flow valve MV₁ is arranged directly on the master fluid conduit 1, which main flow valve MV₁ is able to completely shut off the flow in the master fluid conduit 1.

A bypass loop BL is arranged on the first upper end of the master fluid conduit 1, which bypass loop BL starts upstream of the first pig stopper 3 and ends downstream of the first main flow valve MV₁.

The bypass loop BL is connected to a purge fluid inlet pipe 8, which is able to supply purge fluid by activating a purge fluid pump PP arranged on said purge fluid inlet pipe 8. Two shut off valves V₇ and V₈ are arranged into the bypass loop BL, one on each side of the junction where the purge fluid inlet pipe 8 is connected to the bypass loop BL. The bypass loop BL is also connected to another supply pipe 9 having a shut off valve V₉.

All the above described elements are located on the sea surface, normally on a floating vessel or similar, fixed platform or on shore.

The three dedicated storage tanks T₄, T₅, T₆ are located on the seabed and are supposed to be filled up as desired via the master fluid conduit 1. Each tank T₄, T₅, T₆ can be of a collapsible design, i.e. be a rubber bladder 11 which is partly filled with seawater and a diaphragm defining a partition between a dedicated liquid or fluid and the seawater within the bladder 11.

The respective tanks T₄, T₅, T₆ are interconnected by a second manifold M₂ ending in a second lower end of the master fluid conduit 1. Each tank T₄, T₅, T₆ is in turn connected to an inlet pipe having an inlet valve V₁₀, V₁₁, V₁₂ that enables filling up the tanks T₄, T₅, T₆ with respective liquids or fluids. Further, each tank T₄, T₅, T₆ is provided with an outlet pipe having an outlet valve V₁₃, V₁₄, V₁₅ that enables draining from the respective tanks T₄, T₅, T₆ into a dedicated gear on a subsea installation. Each tank T₄, T₅, T₆ is provided with a vent pipe filter 10 on top to be able to ventilate each tank according to their respective filling level or degree. The second manifold M₂ is provided with a main inlet valve V₁₆ on the junction from the master fluid conduit 1.

At the second lower end of the master fluid conduit 1, a pig receiver 12 is provided, which pig receiver 12 is defined by a third pig stopper 13, two more master valves MV₂ and MV₃ arranged directly on the master fluid conduit 1. Upstream of the third pig stopper 13 the second main flow valve MV₂ is arranged, and downstream the third pig stopper 13 the third main flow valve MV₃ is arranged, which main flow valves MV₂ and MV₃ are able to completely shut off the flow in the master fluid conduit 1. The pig receiver may have a filter 14 and can be retrievable to reclaim the pigs 6, 7 after use. Further, the lower end of the master fluid conduit 1 can be joined by means of respective clamps 15 in order to be able to retrieve the entire or parts of the subsea assembly to the surface, if necessary or desired, for example if maintenance work is to be performed.

An operational sequence will now be described with reference to FIGS. 7 to 14 that show various stages of such operation.

FIG. 7 shows the initial stage where the pig launcher 2 is emptied for purge fluid behind the first main flow valve MV₁ and the pig launcher door 5 opens. The first and second pigs 7, 6 are placed into the pig launcher 2 between the first and second pig stoppers 3, 4. Then the pig launcher door 5 is closed. An outlet valve V₄ from the tank T₁ is opened in addition to the first main flow valve MV₁, and the first pig stopper 4 is unlocked to set the first pig 7 free. The product pump Pi starts feeding the first product from tank Ti in between the respective pigs 6, 7. The first pig 7 displaces the purge fluid in the master fluid conduit 1 out of the conduit. The second pig 6 closes behind.

FIG. 8 shows a second stage where the product pump P₁ is feeding as desired until the first pig 7 is stopped by the third pig stopper 13. Then the subsea valves V₁₆ and V₁₀ are opened in order to open up the passage to storage tank T₄ and the first product is then filled into said dedicated tank T₄.

FIG. 9 shows a third stage when the correct volume of the first product is pumped into the dedicated storage tank T₄, and the outlet valve V₄ from the tank T₁ will be closed. Purge fluid is now pumped via purge fluid inlet pipe 8 up behind the second pig 6 by means of the purge fluid pump PP. The purge fluid displaces the first product in the master fluid conduit 1 up into the subsea storage tank T₄.

FIG. 10 shows the above situation in a fourth stage when the second pig 6 is on its way down to the third pig stopper 13 and has just passed the second main flow valve MV₂. Thus it is to be understood that the first fluid is in front of the second pig 6, while the purging fluid is behind the second pig 6.

FIG. 11 shows a fifth stage where the second pig 6 has been stopped against the first pig 7 at the third pig stopper 13. Now the valves V₁₆ and V₁₀ to the subsea storage tank 4 are closed.

FIG. 12 shows a sixth stage when the third pig stopper 13 is opened up and both the first and second pigs 7, 6 are forced into the pig receiver 12 together with purging fluid.

FIG. 13 shows a seventh stage where the procedure according to FIG. 1 is repeated with product number 2 to be drained from a second surface tank T₂ and then transported to a second subsea storage tank T₅. This is performed by use of a second set of pigs.

FIG. 14 shows an eight stage similar to the FIG. 2 situation where the second fluid is in transfer from the surface tank T₂ to the subsea storage tank T₅ with respective valves V₅, MV₁, MV₂, V₁₆ and V₁₁ in open position.

The transfer of a third fluid from a third surface tank T₃ to a third subsea storage tank T₆ will take place in similar manner by use of a third set of pigs and respective valves to be open and closed.

As indicate also a method for transporting various fluids trough a master flow conduit from the surface to seabed installed tanks or vessels is provided, where respective pig sets are used in combination with a pig launcher and a pig receiver in addition to a number of valves, branch off pipes and a purging fluid, to enable separate transfer of fluid batches, which is enabled in that predetermined valves are operated either to open up or shut down a flow, in combination with operation of the pig launcher to send out one pig at the time to create a fluid partition between each fluid batch transported through said master flow conduit.

1. An installation tool arrangement to enable installation of a flexible elongated element into a pipeline and to extend said flexible elongated element from the surface of the sea to the seabed by the use of a per se known pipeline pigging technique, said installation tool arrangement comprising:
a first pipe junction tool at the pipeline entrance end for the flexible elongated element; and
a second pipe junction tool at the pipeline exit end for the flexible elongated element,
a leading pig connected to said flexible elongated element and arranged to enter said pipeline at said first pipe junction tool, said pig and trailing flexible elongated element entering said pipeline via a branch off pipe of said first pipe junction tool, said pig and flexible elongated element being prepared to be advanced through said pipeline toward the seabed by advancing said pig by means of the fluid flowing in the pipeline; and
a shifting mechanism configured to shift said flexible elongated element to a connecting terminal for said flexible elongated element at the second pipe junction tool.

2. The installation tool arrangement according to claim 1, wherein said first pipe junction tool is a retrofit tool prepared for retrofit installation in a pipeline.

3. The installation tool arrangement according to claim 2, wherein said first pipe junction tool is a retrofit tool arranged with flanges for connection to a cut off pipeline provided with respective flanges.

4. The installation tool arrangement according to claim 1, wherein said branch off pipe of said first pipe junction tool includes a seal box with a seal package sealing around the flexible elongated element during the advancement thereof through the pipeline.

5. The installation tool arrangement according to claim 1, wherein said first pipe junction tool is a modified pig launcher.

6. The installation tool arrangement according to claim 1, wherein said first pipe junction tool further includes a cable conveyor to assist in feeding and advancing said flexible elongated element.

7. The installation tool arrangement according to claim 1, wherein said second pipe junction tool is a retrofit tool prepared for retrofit installation in a pipeline.

8. The installation tool arrangement according to claim 7, wherein said second pipe junction tool is a retrofit tool arranged with flanges, or a subsea connector system, for connection to a cut off pipeline provided with respective flanges, or a subsea connector system.

9. The installation tool arrangement according to claim 7, wherein said second pipe junction tool is a modified pig receiver.

10. The installation tool arrangement according to claim 7, wherein said second pipe junction tool includes a pig receiver housing and a pig receiver slide, said pig receiver slide being able to shift said flexible elongated element to said connecting terminal for said flexible elongated element at said second pipe junction tool.

11. A subsea filler line system comprising:
the integrated installation tool arrangement according to claim 1, wherein said subsea filler line system is adapted to transport different types of fluids in separate batches through one single supply conduit, or flexible line, from the sea surface to respective dedicated storage tanks, or vessels, installed on the seabed;
respective valves and control systems to operate the subsea filler line system; and
at least two pigs adapted to be pushed by the transported fluid through said supply conduit, or flexible line,
wherein the pigs provide a barrier between the respective fluids in front of and behind each pig, thus being able to define respective fluid batches between following pigs, each fluid batch being directed by means of valves through an inlet into said supply conduit and an outlet from said supply conduit and further on to the respective dedicated storage tanks, or vessels, on the seabed.

12. The subsea filler line system according to claim 11, further comprising a pig launcher comprising a pig stopper able to both retain a pig and release a pig into said supply conduit.

13. The subsea filler line system according to claim 11, wherein said pig launcher comprises said fluid inlet and said pig stopper, said inlet and said pig stopper being spaced apart by at least one pig length.

14. The subsea filler line system according to claim 11, further comprising a pig lock adjacent to the subsea storage tanks comprising a pig stopper able to both retain a pig and discharge a pig into a pig receiver, said pig receiver, as an option, being retrievable.

15. The subsea filler line system according to claim 14, wherein said pig lock comprises said fluid outlet and said pig stopper, said outlet and said pig stopper being spaced apart by at least one pig length.

16. The subsea filler line system according to claim 11, further comprising a battery of subsea storage tanks interconnected by a pipe manifold, the pipe manifold having a respective branch pipe to each individual storage tank, each respective branch pipe being provided with an inlet valve able to shut off/open up the flow to said storage tank by means of said control system.

17. The subsea filler line system according to claim 16, wherein each subsea storage tank, or respective branch pipe, includes a fluid pipe with a shut off/open up valve extending to a dedicated equipment on a subsea installation, said valve being operated by means of said control system.

18. The subsea filler line system according to claim 11, wherein said single supply conduit includes a first shut off/open up mainline valve adjacent to the pig launcher and a second shut off/open up mainline valve adjacent to the pig lock on the seabed, the valves being operable by means of said control system and enabling installation/replacement of said single supply conduit.

19. The subsea filler line system according to claim 11, wherein said single supply conduit includes a third shut off/open up mainline valve adjacent to, but in the extension of the pig lock on the seabed, the valve being operated by means of said control system and enabling isolation of the filler line system when replacing the pig receiver.

20. A method for introducing a flexible elongate element into a pipeline transporting fluids from the surface to the seabed, comprising the steps of:
installing a first pipe junction, having a main pipe and a branch off pipe, on the pipeline, which first pipe junction includes a pig being prepared to be launched into said pipeline, and to which said flexible elongate element is secured, which flexible elongate element is coming into said pipeline via said branch off pipe and in a sealed way;
exposing said pig for a fluid flow in said pipeline, which displaces said pig in the flow direction;
continue continuing to displace said pig and said flexible elongate element by said fluid flow until said pig reaches a pig receiver installed on said pipeline on the seabed;
letting said pig enter a pig receiver slide in said pig receiver; and
shifting said pig and pig receiver to slide out of said pipeline pathway to enable to resume full flow through said pipeline.
